(19) United States
(12) Patent Application Publication
(10) Pub. No.: US 2024/0412271 A1
(43) Pub. Date: Dec. 12, 2024

(54) EXPLORING USER INTERESTS WITH MULTI-ARM BANDIT (MAB), CONTEXTUAL MAB, AND REINFORCEMENT LEARNING IN RECOMMENDATION

(71) Applicant: ROKU, INC., San Jose, CA (US)

(72) Inventors: Fei XIAO, San Jose, CA (US); Lian LIU, Rancho Palos Verdes, CA (US); Jose SANCHEZ, San Jose, CA (US); Nam VO, San Jose, CA (US); Atishay JAIN, San Bruno, CA (US); Ronica JETHWA, Mountain View, CA (US); Pulkit AGGARWAL, San Jose, CA (US); Rohit MAHTO, San Jose, CA (US); Abhishek BAMBHA, Burlingame, GA (US); Amit VERMA, Sunnyvale, CA (US); Daniel MEROPOL, Brooklyn, NY (US); Rameen MAHDAVI, San Jose, CA (US)

(21) Appl. No.: 18/208,717

(22) Filed: Jun. 12, 2023

(51) Int. Cl. G06Q 30/0601

(52) U.S. Cl. CPC G06Q 30/0631

(57) ABSTRACT

Disclosed herein are system, method and/or computer program product embodiments, and/or combinations and sub-combinations thereof, for recommending content to a user. An embodiment identifies a first set of content items based at least on a first set of weights respectively associated with different user interests, causes the first set of content items to be presented to the user, determines a measure of user interaction with the first set of content items, provides the measure of user interaction to one of a multi-arm bandit (MAB), contextual MAB, or reinforcement learning model that selects, based at least on the state information and the measure of user interaction, a second set of weights respectively associated with the different user interests, identifies a second set of content items based at least on the second set of weights, and causes the second set of content items to be presented to the user.

### BACKGROUND

### Field

This disclosure is generally directed to computer-implemented recommendation systems.

### Background

Cold start is a potential problem in computer-based information systems which involve a degree of automated data modeling. Specifically, it concerns the issue that the system cannot draw any inferences for users or items about which it has not yet gathered sufficient information.

The cold start problem is a well-known problem for recommendation systems. Recommendations systems form a specific type of information filtering technique that attempts to present items (e.g., movies, TV shows, music, books, news, images, web pages, e-commerce) that are likely of interest to the user. Typically, a recommendation system compares the user's profile to some reference characteristics. These characteristics may be related to item characteristics (content-based filtering) and/or the user's social environment and past behavior (collaborative filtering). Depending on the system, the user can be associated to various kinds of interactions: clicks, launches, ratings, bookmarks, purchases, likes, number of page visits etc.

A new user can present a cold start problem for recommendation systems. When a new user enrolls in the system, for a certain period of time the recommendation system has to provide recommendations without being able to rely on the user's past interactions, since none have occurred yet. This problem is of particular importance when the recommendation system is part of the service offered to users, since a user who is faced with recommendations of poor quality might soon decide to stop using the service before providing enough interaction to allow the recommendation system to understand his/her interests. One strategy in dealing with new users is to ask them to provide some preferences to build an initial user profile. However, this places a burden on users and if the registration process is too long, it might induce too many users to abandon it.

An interesting variant of the aforementioned cold start problem can arise when multiple users share a single user account. If one of the users sharing the user account is a new or infrequent user, then the recommendation system may have very little or no interaction data for the new/infrequent user upon which to base recommendations. Consequently, the recommendation system may present the new/infrequent user with items that only correspond to the interests of the other more active users sharing the user account.

Another challenge for recommendation systems is the so-called “filter bubble” effect. This refers to a phenomenon that can occur when the user's past interactions are limited to only a small number of interest areas. In such a scenario, the recommendation system may only recommend items in the same interest area(s), since it has no other interaction data to rely on. The filter bubble effect can prevent a user from easily discovering items outside of the interest area(s) they've historically interacted with, thereby leading to an unsatisfactory user experience and reduced engagement with the system.

One possible approach to dealing with the cold start problem is to default to presenting new users with items that are most popular across an entire user base. However, this approach has several drawbacks. First, the popularity of any given item will be driven by the active users of the system, which means that the items that are recommended will be biased toward the interest areas of those active users, which may not represent the interest areas of all users. Furthermore, item popularity may be a relatively static feature, which means that such an approach will limit the user's ability to explore items in other interest areas not well represented by the popular items.

### SUMMARY

Provided herein are system, apparatus, article of manufacture, method and/or computer program product embodiments, and/or combinations and sub-combinations thereof, for recommending content items to a user. An example embodiment operates by identifying a first set of content items to recommend to the user based at least on a first set of weights respectively associated with different user interests in a plurality of user interests, causing the first set of content items to be presented to the user, determining a measure of user interaction with the first set of content items, providing the measure of user interaction with the first set of content items to a machine learning (ML) model that comprises one of a multi-arm bandit (MAB) model, a contextual MAB (CMAB model) or a reinforcement learning (RL) model and that selects, based at least on the state information and the measure of user interaction with the first set of content items, a second set of weights respectively associated with the different user interests, identifying a second set of content items based at least on the second set of weights, and causing the second set of content items to be presented to the user.

In an embodiment, determining the measure of user interaction with the first set of content items comprises determining a measure of one or more of: user selections of content items in the first set of content items, user launches of content items in the first set of content items for playback, or user playback durations of content items in the first set of content items.

In another embodiment, the ML model comprises the CMAB model, the method further comprises providing context information to the ML model, and selecting the second set of weights respectively associated with the different user interests comprises selecting, by the ML model and based at least on the context information and the measure of user interaction with the first set of content items, the second set of weights respectively associated with the different user interests. In further accordance with such an embodiment, providing the context information to the ML model may comprise providing one or more of a day of a week, a time, a date, a location, or a device type.

In yet another embodiment, the ML model comprises the RL model, the method further comprises providing state information to the ML model, and selecting the second set of weights respectively associated with the different user interests comprises selecting by the ML model and based at least on the state information and the measure of user interaction with the first set of content items, the second set of weights respectively associated with the different user interests. In further accordance with such an embodiment, providing the state information to the ML model may comprise providing one or more of: a retention rate associated with the user; a measure of activity of the user with respect to a media system; a measure of engagement by the user with content items per session; an indication of diversified items viewed by the user; exploration or collaborative filtering information associated with a user interest of the user, or context information.

In still another embodiment, the plurality of user interests comprise a plurality of genres or a plurality of content item clusters.

In a further embodiment, selecting the second set of content items to recommend to the user based at least on the second set of weights comprises determining a similarity score for each candidate content item in a set of candidate content items based on a measure of similarity between an item embedding that represents the given candidate content item and a user embedding that represents the user with respect to a user interest associated with the given candidate content item, identifying a set of top-ranked candidate content items for each user interest based on the similarity score for each candidate content item and the user interest associated with each candidate content item, and selecting the second set of content items from among the sets of top-ranked candidate content items based on the second set of weights.

In a yet further embodiment, selecting the second set of weights comprises selecting the second set of weights based at least on the measure of user interaction with the first set of content items and historical trial information that specifies, for each of one or more prior trials, at least a set of weights selected by the ML model and a measure of user interaction with a set of content items identified based on the set of weights selected by the ML model and presented to the user.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a content recommendation system, according to some embodiments.

FIG. 4 illustrates a block diagram of a reinforcement learning (RL) system that may be used to implement a content recommendation system, according to some embodiments.

FIG. 5 illustrates a flow diagram of a method for recommending content to a user, according to some embodiments.

FIG. 6 illustrates a flow diagram of a method for identifying content items to recommend to a user based on a set of user interest weights selected by an ML model, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for recommending content items to a user. An example embodiment operates by identifying a first set of content items to recommend to the user based at least on a first set of weights respectively associated with different user interests in a plurality of user interests, causing the first set of content items to be presented to the user, determining a measure of user interaction with the first set of content items, providing state information and the measure of user interaction with the first set of content items to a reinforcement learning (RL) model that selects, based at least on the state information and the measure of user interaction with the first set of content items, a second set of weights respectively associated with the different user interests, identifying a second set of content items based at least on the second set of weights, and causing the second set of content items to be presented to the user.

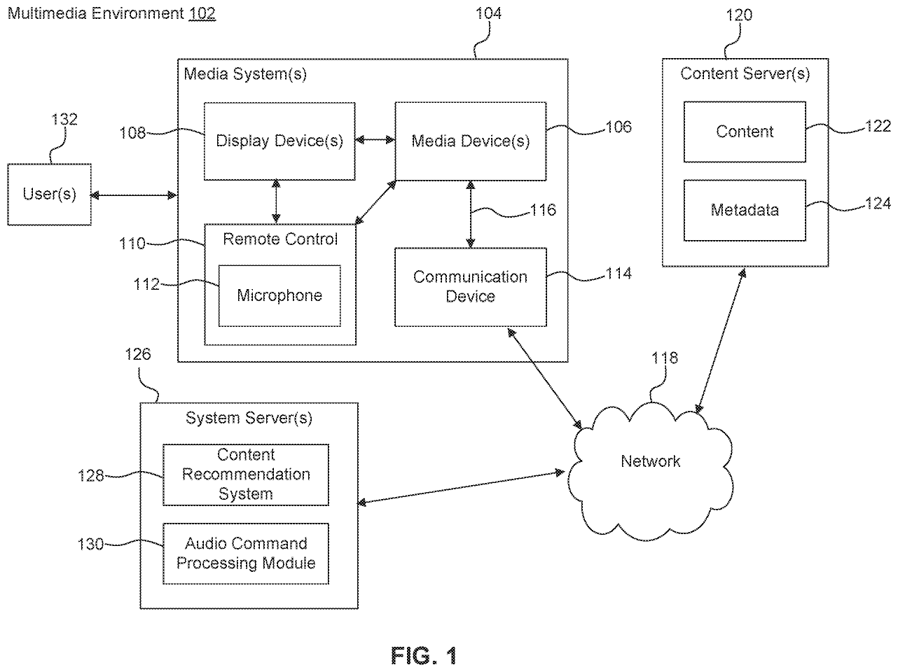

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (loT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as Wi-Fi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, which is further described below.

Multimedia environment 102 may include a plurality of content servers 120 (also called content providers, channels or sources 120). Although only one content server 120 is shown in FIG. 1, in practice multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

System servers 126 may include a content recommendation system 128. Content recommendation system 128 may be configured to identify content items of interest to user 132, such as particular content items stored by content servers 120. For example, content recommendation system 128 may utilize information about user 132 and content items stored by content servers 120 to identify a set of recommended content items for user 132. Content recommendation system 128 may then transmit information about the recommended content items to media device 106 for presentation to user 132 via a user interface (e.g., a graphical user interface (GUI)). The user interface may be displayed by media device 106 via display device 108. The user interface may include controls that a user may interact with to obtain additional information about each recommended content item and/or to play each recommended content item.

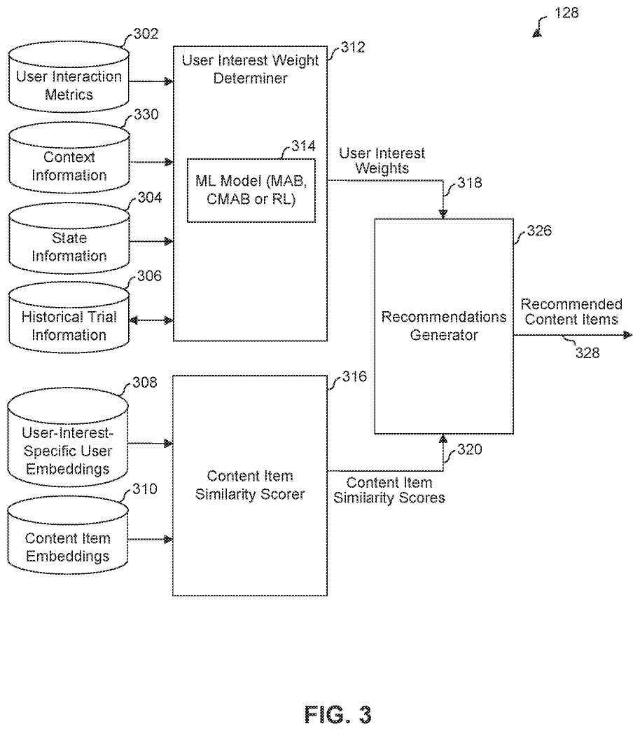

Further details concerning an example implementation of content recommendation system 128 will be provided below in reference to FIGS. 3-8.

System servers 126 may also include an audio command processing module 130. As noted above, remote control 110 may include microphone 112. Microphone 112 may receive audio data from users 132 (as well as other sources, such as the display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which then forwards the audio data to audio command processing module 130 in system servers 126. Audio command processing module 130 may operate to process and analyze the received audio data to recognize a verbal command of user 132. Audio command processing module 130 may then forward the verbal command back to media device 106 for processing.

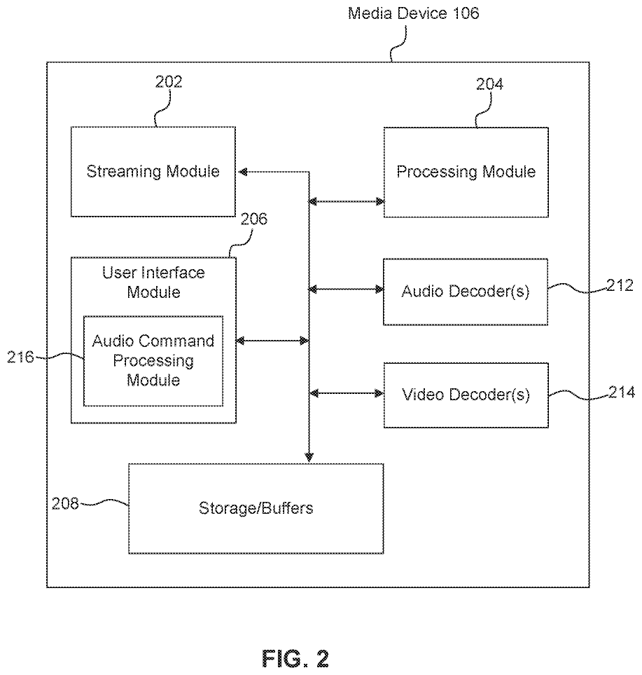

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

FIG. 2 illustrates a block diagram of an example media device 106, according to some embodiments. Media device 106 may include a streaming module 202, a processing module 204, storage/buffers 208, and a user interface module 206. User interface module 206 may be configured to present a search interface associated with personalized retrieval system 128 to user 132 via display device 108. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmy, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select a content item, such as a movie, TV show, music, book, application, game, etc. For example, user 132 may select a content item from among a set of recommended content items identified by content recommendation system 128. In response to the user selection, streaming module 202 of media device 106 may request the selected content item from content server(s) 120 over network 118. Content server(s) 120 may transmit the requested content item to streaming module 202. Media device 106 may transmit the received content item to display device 108 for playback to user 132.

In streaming embodiments, streaming module 202 may transmit the content item to display device 108 in real time or near real time as it receives such content item from content server(s) 120. In non-streaming embodiments, media device 106 may store the content item received from content server(s) 120 in storage/buffers 208 for later playback on display device 108.

### Personalized Retrieval System

FIG. 3 illustrates a block diagram of content recommendation system 128, according to some embodiments. As noted above, content recommendation system 128 may be implemented by system server(s) 126 in multimedia environment 102 of FIG. 1. As also noted above, content recommendation system 128 may identify a set of recommended content items for user 132 and media device 106 may present information about and/or controls for playing back such recommended content items via a user interface that is displayed to user 132 via display device 108. As will be discussed in further detail herein, content recommendation system 128 may utilize a machine learning (ML) model comprising one of a multi-arm bandit (MAB) model, a contextual MAB (CMAB) model or a reinforcement learning (RL) model to generate content item recommendations across various user interests in a manner that exploits known user interests while also exploring unknown user interests.

As shown in FIG. 3, personalized retrieval system 128 may comprise a user interest weight determiner 312, a content item similarity scorer 316, and a recommendations generator 326. Each of these components may be implemented by processing logic that can comprise hardware (e.g., circuitry, dedicated logic, programmable logic, microcode, etc.), software (e.g., instructions executing on a processing device), or a combination thereof. Each of these components will now be described.

User interest weight determiner 312 may operate to select a set of user interest weights 318 to be assigned to different user interests in a plurality of user interests for each trial t in a series of content recommendation trials, t=1, 2, 3, . . . . As will be discussed herein, user interest weights 318 selected for trial t will be used to identify a set of content items to recommend to user 132 during trial t. The duration of a trial may depend upon the implementation, and may be a configurable operating parameter of content recommendation system 128.

The plurality of user interests may comprise, for example, a plurality of genres or categories to which content items may be assigned based on factors such as style, form or content (e.g., action, animation, romance, comedy, drama, adventure, horror, western, documentary, science fiction, fantasy, crime, thriller, mystery, or musical). Alternatively, the plurality of user interests may comprise, for example, a plurality of content item clusters identified by an unsupervised machine learning model. For example, a clustering algorithm may be applied to the content items stored by content server(s) 120 to identify a plurality of distinct or overlapping clusters of content items, wherein each cluster may be deemed to represent a different user interest. An example of one such clustering algorithm is described in commonly-owned co-pending U.S. patent application Ser. No. 17/943,526, entitled “Content Display and Clustering System.” However, any of a wide variety of clustering algorithms currently known or hereinafter developed may be used to generate such content item clusters.

User interest weight determiner 312 utilizes an ML model 314 to generate user interest weights 318 for each content recommendation trial t, wherein ML model 314 comprises one of a MAB model, a CMAB model or an RL model. In particular, user interest weight determiner 312 provides a number of inputs to ML model 314 and, based on those inputs, ML model 314 selects user interest weights 318 for trial t. As shown in FIG. 3, the inputs include user interaction metrics 302 and historical trial information 306, and may also include context information 330 and/or state information 304.

User interaction metrics 302 may include a measure of interaction by user 132 with a set of content items presented to user 132 by content recommendation system 128 during a previous content recommendation trial, which may be thought of as trial t−1. User interaction metrics 302 may additionally or alternatively include data from which such a measure may be calculated or otherwise derived by user interest weight determiner 312. For example, and without limitation, the measure of user interaction may include or be based on a measure of a number of times user 132 selected any of the content items presented to user 132 during the previous trial (e.g., clicked on a UI control to obtain information about a content item), a number of times user 132 launched for playback any of the content items presented to user 132 during the previous trial, and/or an amount of time user 132 played back any of the content items presented to user 132 during the previous trial. However, these are examples only and are not intended to be limiting. In embodiments, user interaction metrics 302 may be obtained based on system logs that record user-item interactions conducted by user 132 via media system 104 and/or using media device(s) 106.

Context information 330 may comprise any type of information describing a circumstance or setting that may be taken into account when generating user interest weights 318 for trial t. By way of example only and without limitation, context information 330 may include temporal information such as the day of the week, the time of day, or the date, a location of user 132, or a device type being used by user 132. Still other types of information may be included in context information 330.

State information 304 may comprise information relating to a state of user 132. For example, in embodiments, state information 304 may comprise one or more metrics or indicators relating to the interaction of user 132 with media system 104 and/or media device(s) 106. By way of further example, state information 304 may include one or more of a retention rate associated with user 132, a measure of activity of user 132 with respect to media system 104 and/or media device 106, a measure of engagement by user 132 with content items per session with media system 104 and/or media device 106, an indication of diversified items viewed/consumed by the user 132, and/or exploration and collaborative filtering information associated with a user interest of user 132. State information 304 may include other metrics or indicators relating to the interaction of user 132 with media system 104 and/or using media device 106. In some embodiments, the metrics or indicators may be based on data collected both during and before the previous content recommendation trial, such that state information 304 presents a more long-term view of user 132 than, for example, the aforementioned user interaction metrics 302 which may be based only on data collected during the previous content recommendation trial.

In embodiments, user state information 304 may include other information about user 132, including but not limited to demographic data about user 132.

Historical trial information 306 comprises information about previous trials for which user interest weights 318 were selected and for which user content item recommendations were generated. For example, in embodiments, historical trial information 306 specifies, for each of one or more prior trials, user interest weights 318 that were selected by ML model 314, and a measure of user interaction with a set of content items identified by content recommendation system 128 based on those weights and presented to user 132. In further embodiments, historical trial information may further specify, for each of one or more prior trials, context information 330 that was provided to ML model 314 and/or state information 304 that was provided to ML model 314.

After ML model 314 has selected user interest weights 318 for content recommendation trial t, user interest weight determiner 312 provides such weights to content item ranker 322.

Content item similarity scorer 316 may operate to generate a content item similarity score for each candidate content item in a plurality of candidate content items with respect to user 132, thereby generating a set of content item similarity scores 320. The candidate content items may comprise, for example, content items stored by content server(s) 120 or a subset of such content items. In an embodiment, content item similarity scorer 316 may determine the similarity score for a given candidate content item by determining a measure of similarity between (i) an item embedding that represents the given candidate content item; and (ii) a user embedding that represents user 132 with respect to a user interest associated with the given candidate content item.

An item embedding may comprise a vector representation of a candidate content item within a latent space (also known as a latent feature space or embedding space). In an embodiment, content recommendation system 128 may store an item embedding for each candidate content item in a data store 310 as shown in FIG. 3. A user embedding may comprise a vector representation of user 132 within the same latent space in which the item embeddings are represented. Various techniques are known in the art for generating item embeddings and user embeddings.

In an embodiment, content recommendation system 128 may store a different user embedding for user 132 with respect to each of the aforementioned different user interests. These multiple user-interest-specific embeddings for user 132 may be stored in a data store 308 as shown in FIG. 3. Generating and storing multiple user embeddings for user 132 with respect to different user interests may be deemed advantageous since a user having a set of diverse interests may not be well described by a single user embedding and the variety of a user's interests may be better captured by this more complex representation. As will be discussed herein, use of multiple user embeddings for a single user enables content items to be evaluated for recommendation with respect to each one of the user's interests.

For example, in an embodiment in which user interests are represented by genres, content item recommendation system 128 may store a first user embedding for user 132 with respect to content items in the action genre, a second user embedding for user 132 with respect to content items in the animation genre, a third user embedding for user 132 with respect to content items in the romance genre, and so on. The user embedding for user 132 with respect to a particular genre may be generated, for example, by averaging the item embeddings of all of the content items with which user 132 has interacted in that genre, provided that there is user interaction data with the particular genre. In a situation in which there is no user interaction data with the particular genre, then the user embedding for user 132 with respect to the particular genre may be generated, for example, by averaging all the item embeddings in that genre. However, these are only examples, and other methods may be used to generate user embeddings for user 132 with respect to different genres.

As another example, in an embodiment in which user interests are represented by different content item clusters, content item recommendation system 128 may store a first user embedding for user 132 with respect to a first content item cluster, a second user embedding for user 132 with respect to a second content item cluster, a third user embedding for user 132 with respect to a third content item cluster, and so on. The user embedding for user 132 with respect to a particular content item cluster may be generated, for example, by averaging the item embeddings of all of the content items with which user 132 has interacted in that content item cluster, provided that there is user interaction data with the particular content item cluster. In a situation in which there is no user interaction data with the particular content item cluster, then the user embedding for user 132 with respect to the particular content item cluster may be generated, for example, by averaging all the item embeddings in that content item cluster. However, these are only examples, and other methods may be used to generate user embeddings for user 132 with respect to different content item clusters.

In further accordance with the foregoing examples, content item similarity scorer 316 may determine the similarity score for a given candidate content item that is assigned to a particular genre by determining a measure of similarity between an item embedding that represents the given candidate content item and a user embedding that represents user 132 with respect to the particular genre. Likewise, content item similarity scorer 316 may determine the similarity score for a given candidate content item that is assigned to a particular content item cluster by determining a measure of similarity between an item embedding that represents the given candidate content item and a user embedding that represents user 132 with respect to the particular content item cluster.

Determining the measure of similarity between an item embedding and a user embedding may comprise, for example and without limitation, determining a cosine distance between the item embedding and the user embedding, determining a dot product distance between the item embedding and the user embedding, determining a Euclidean distance between the item embedding and the user embedding, determining a Manhattan distance between the item embedding and the user embedding, or determining a Hamming distance between the item embedding and the user embedding.

Although a particular technique has been described above for generating content item similarity scores 320 that relies on item embeddings and multiple user-interest-specific user embeddings, it is to understood that this technique has been described by way of example only and is not intended to be limiting. Content item similarity scorer 316 may use any suitable method for generating generate a content item similarity score for each candidate content item with respect to user 132.

After content item similarity scorer 316 has generated a similarity score for each of the candidate content items, it provides content item similarity scores 320 to content item ranker 322.

Recommendations generator 326 may operate to receive user interest weights 318 from user interest weight determiner 312 and content item similarity scores 320 from content item similarity scorer 316 and, based on this information, select a set of recommended content items 328 to present to user 132 during content recommendation trial t.

For example, in embodiments, based on content item similarity scores 320 and the user interests associated with the aforementioned candidate content items, recommendations generator 326 may generate a separate ranking of the candidate content items with respect to each user interest. Thus, for example, recommendations generator 326 may generate a ranking of candidate content items in the horror genre based on similarity score, a ranking of candidate content items in the action genre based on similarity score, and a ranking of candidate content items in the comedy genre based on similarity score. Recommendations generator 326 may then select a certain number of candidate content items from among the top-ranked candidate content items in each user interest based on user interest weights 318 to determine recommended content items 328. For example, if the user interest weights are 0.3 for the horror genre, 0.3 for the action genre and 0.4 for the comedy genre and recommendations generator 326 is configured to generate 40 recommended content items 328 for user 132, then recommendations generator 326 may select the top-ranked 0.3*40 (i.e., 12) candidate content items 328 in the horror genre, the top-ranked 0.3*40 (i.e., 12) candidate content items in the action genre, and the top-ranked 0.4*40 (i.e., 16) candidate content items in the comedy genre.

Alternatively, recommendations generator 326 may operate to determine a ranking score for each candidate content item in the aforementioned plurality of candidate content items and then select recommended content items 328 based on such ranking score. For example, recommendations generator 326 may determine the ranking score for a given candidate content item as a function of (i) the similarity score for the given candidate content item as determined by content item similarity scorer 316; and (ii) the user interest weight that is assigned to the user interest associated with the given candidate content item by user interest weight determiner 312. This approach may be represented as:

$$ranking\_score = f ( interest\_weight , item\_similarity \_score ) \qquad ( Eq . 1 )$$

wherein ranking_score is the ranking score for a particular content item, interest weight is the weight assigned to the user interest with which the particular content item is associated (e.g., genre or content item cluster) by interest weight determiner 312 and item_similarity_score is the similarity score assigned to the particular content item by content item similarity scorer 316.

Thus, in embodiments, rather than considering the similarity score of content items alone in generating ranking scores, content item ranker 322 may also take into consideration the weights assigned to the different user interests by user interest weight determiner 312. This feature may enable, for example, content item ranker 322 to assign a higher ranking score to a first content item than it assigns to a second content item having the same similarity score if the first content item is associated with a more heavily weighted user interest than the second content item. Put another way, this feature enables user interest weight determiner 312 to control, to some degree, ranking scores that may be assigned to content items by recommendations generator 326, and thus what content items will be recommended to user 132.

Recommendations generator 326 may further cause information associated with each content item included in recommended content items 328 to be transmitted to media device 106 for presentation to user 132. Such information may include, for example and without limitation, a title of the content item, an icon or image associated with the content item, a content description associated with the content item, a link that activates playback of the content item, or the like. Media device 106 may present such information to user 132 via a GUI rendered to display device 108. In an embodiment, the GUI enables user 132 to interact with (e.g., click on) a first GUI control associated with each content item included within recommended content items 328 to obtain additional information about the corresponding content item and/or a second GUI control associated with each content item included within recommended content items 328 to play back (e.g., stream) the corresponding content item.

During content recommendation trial t, content recommendation system 128 may monitor interactions by user 132 with recommended content items 328 and update user interaction metrics 302 accordingly. After content recommendation trial t ends, and at the beginning of content recommendation trial t+1, content recommendation system 128 may also update context information 330 and state information 304 to reflect any changes thereto, as well as historical trial information 306. User interest weight determiner 312 may then provide some or all of these revised inputs (user interaction metrics 302 for trial t, updated context information 330, updated state information 304, and updated historical trial information 306) to ML model 314 to generate a new set of user interest weights 318 for trial t+1. Content recommendation system 128 may also update the user-interest-specific user embeddings stored in data store 308 to reflect any additional user-item interactions that may have occurred during trial t, which in turn may be used by content item similarity scorer 316 to generate a new set of content item similarity scores 320 for trial t+1. The new set of user interest weights 318 and the new set of content item similarity scores 320 may then be used to select a new set of recommended content items 328 for user 132 for content recommendation trial t+1. Content recommendation system 128 may repeat this process for each content recommendation trial t=1, 2, 3, . . . .

In embodiments, ML model 314 may comprise an MAB model, such as an epsilon-greedy algorithm or an upper confidence bound (UCB) algorithm). The MAB model may operate based on user interaction metrics 302 and historical trial information 306 to predict a particular set of user interest weights 318 that will maximize user interaction with recommended content items 328.

In further embodiments, ML model 314 may comprise a CMAB model, such as a LinUCB algorithm or a LinRel algorithm. The CMAB model may operate based on user interaction metrics 302, context information 330 and historical trial information 306 to predict a particular set of user interest weights 318 that will maximize user interaction with recommended content items 328. CMAB algorithms such as LinUCB can take into account context information (e.g., a context vector) along with historical action-reward information (as represented by historical trial information 306) in selecting user interest weights 318. This enables the algorithm to search for the best user interest weights 318 within a number of different contexts, wherein each context may be thought of as presenting its own MAB. This may be particularly useful in scenarios in which user 132 is actually a single user account that is being shared by multiple different users, as it allows the CMAB model to utilize context clues to, in effect, distinguish between the different users and thereby provide more targeted content recommendations to each. The LinUCB algorithm is described in L. Li et al., “A Contextual-Bandit Approach to Personalized News Article Recommendation,” WWW '10, pp. 661-670 (2010).

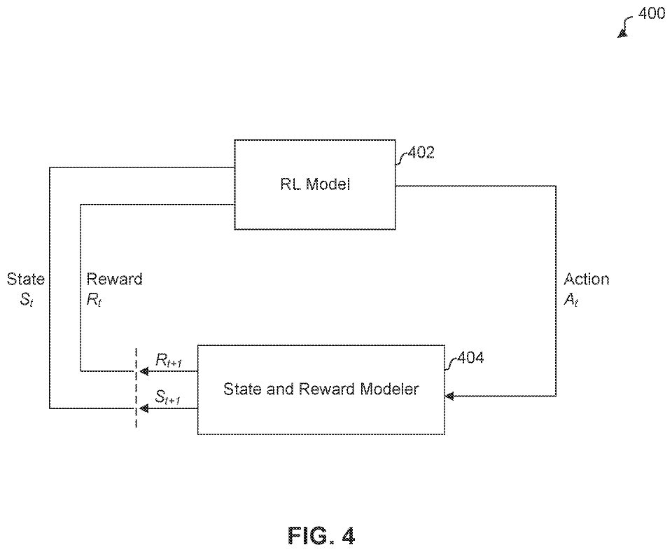

In still further embodiments, ML model 314 may comprise an RL model. In this regard, FIG. 4 illustrates a block diagram of an RL system 400 that may be used to implement content recommendation system 128, according to some embodiments. For example, RL system 400 may be used to implement user interest weight determiner 312 as described above in reference to FIG. 3. As shown in FIG. 4, RL system 400 may include an RL model 402 (which may be analogous to ML model 314 in FIG. 3) and a state and reward modeler 404. Each of these components may be implemented by processing logic that can comprise hardware (e.g., circuitry, dedicated logic, programmable logic, microcode, etc.), software (e.g., instructions executing on a processing device), or a combination thereof. Each of these components will now be described.

RL model 402 may operate to select an action Aₜ for each content recommendation trial t, where t=1, 2, 3, . . . . In embodiments, RL model 402 selects the action Aₜ by first selecting a stochastic policy π (a|s) for trial t based on a state Sₜ and a reward Rₜ associated with trial t, and then selects the action Aₜ based on stochastic policy π (a|s). The stochastic policy π (a|s) may specify probabilities for taking action a in each state s. The action Aₜ selected by RL model 402 may be the set of user interest weights 318 for trial t, as discussed above in reference to FIG. 3. Although not shown in FIG. 4, RL model 402 may also select the stochastic policy π (a|s) for trial t based on historical trial information, such as historical trial information 306 as discussed above in reference to FIG. 3.

State and reward modeler 404 may operate to generate information representative of a state Sₜ₊₁ and a reward Rₜ₊₁ associated with a trial t+1, and that may have resulted from the execution of action Aₜ. In embodiments, the state Sₜ₊₁ may be represented by certain information about user 132 (e.g., information relating to user interactions with media system 104 and/or media device 106 and/or demographic information) as well as by certain context information (e.g., day of week, time of day, date, location, or device type). For example, the state Sₜ₊₁ may be represented by any of the information described above in connection with state information 304 of FIG. 3. In embodiments, the reward Rₜ₊₁ may be represented by a measure of user interaction with content items that were recommended based on the set of user interest weights 318 selected as action Aₜ. For example, the reward Rₜ₊₁ may be represented by any of the information described above in connection with user interaction metrics 302.

As shown in FIG. 4, the state Sₜ₊₁ and a reward Rₜ₊₁ associated with trial t+1 becomes the inputs Sₜ and Rₜ that are then used by RL model 402 to select a new stochastic policy π (a|s) for determining Aₜ for the next content recommendation trial. This process may continue for any number of content recommendation trials.

RL system 400 of FIG. 4 is presented in a form that may be associated with a wide variety of RL system implementations. Thus, persons skilled in the relevant art(s) will appreciate that RL model 402 may be implemented using a wide variety of RL algorithms whether currently known or hereinafter developed.

As will be appreciated by persons skilled in the relevant arts, MAB, CMAB and RL models may operate to explore various actions to try and maximize an associated reward. This feature of these models can help address the cold start problem associated with new users, which was described in the Background section above. For example, even if there is a lack of interaction data from which to generate user embeddings (or otherwise drive content item recommendations), the use of a MAB/CMAB/RL model can help ensure that the user will be presented with content items from different user interest areas, thereby providing opportunities for user-item interactions from which the system can learn. The exploration feature of MAB/CMAB and RL models can also help address the filter bubble problem that was described in the Background section, as it can ensure that the user is presented with content items outside of the potentially limited set of interest area(s) they've historically interacted with.

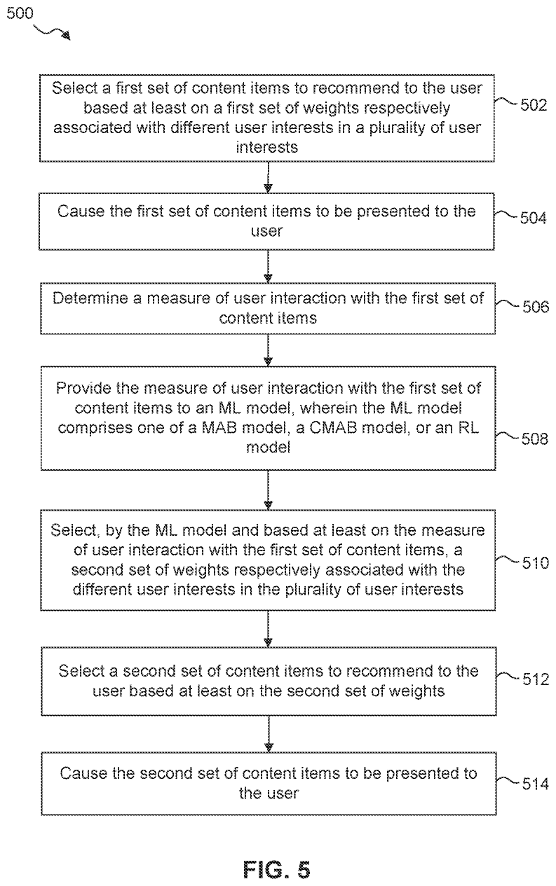

FIG. 5 is a flow diagram for a method 500 for recommending content items to a user, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall first be described with reference to the embodiment of content recommendation system 128 depicted in FIG. 3, although method 500 is not limited to that embodiment.

In 502, recommendations generator 326 selects a first set of recommended content items 328 to recommend to user 132 based at least on a first set of user interest weights 318 (e.g., for trial t) respectively associated with different user interests in a plurality of user interests. As discussed herein, the plurality of user interests may comprise, for example and without limitation, a plurality of genres or a plurality of content item clusters. In the example embodiment of FIG. 3, recommendations generator 326 selects the first set of recommended content items 328 based on user interest weights 318 and content item similarity scores 320.

In 504, recommendations generator 326 causes the first set of recommended content items 328 to be presented to user 132. For example, as discussed herein, recommendations generator 326 may cause information associated with each content item included in the first set of recommended content items 328 to be transmitted to media device 106 for presentation to user 132.

In 506, user interest weight determiner 312 determines a measure of user interaction with the first set of recommended content items 328, e.g., based on user interaction metrics 302. As discussed herein, determining the measure of user interaction with the first set of recommended content items 328 may comprise determining a measure of one or more of user selections of content items in the first set of recommended content items 328, user launches of content items in the first set of recommended content items 328, or user playback durations of content items in the first set of recommended content items 328.

In 508, user interest weight determiner 312 provides the measure of user interaction with the first set of recommended content items 328 to ML model 314, wherein ML model 314 comprises one of an MAB model, a CMAB model, or an RL model.

In 510, ML model 314 selects, based at least on the measure of user interaction with the first set of recommended content items 328, a second set of user interest weights 318 (e.g., for trial t+1) respectively associated with the different user interests in the plurality of user interests. In embodiments, ML model 314 selects the second set of user interest weights 318 based at least on the measure of user interaction with the first set of recommended content items 328 and historical trial information 306 that specifies, for each of one or more prior trials, at least a set of user interest weights 318 selected by ML model 314 and a measure of user interaction with a set of content items identified based on the set of user interest weights 318 selected by ML model 314 and presented to the user.

In 512, recommendations generator 326 selects a second set of recommended content items 328 to recommend to user 132 based at least on the second set of user interest weights 318. In the example embodiment of FIG. 3, recommendations generator 326 selects the second set of recommended content items 328 based on user interest weights 318 and content item similarity scores 320.

In 514, recommendations generator 326 causes the second set of recommended content items 506 to be presented to user 132. For example, as discussed herein, recommendations generator 326 may cause information associated with each content item included in the second set of recommended content items 328 to be transmitted to media device 106 for presentation to user 132.

In an embodiment in which ML model 314 comprises a CMAB model, 508 may also comprise providing context information 330 to ML model 314. In further accordance with such an embodiment, 512 may comprise selecting a second set of user interest weights 318 respectively associated with the different user interests based at least on context information 330 and the measure of user interaction with the first set of content items.

In an embodiment in which ML model 314 comprises an RL model, 508 may also comprise providing state information 304 to ML model 314. In further accordance with such an embodiment, 512 may comprise selecting a second set of user interest weights 318 respectively associated with the different user interests based at least on state information 304 and the measure of user interaction with the first set of content items. As discussed above, the RL model may first select a stochastic policy based at least on state information 304 and the measure of user interaction with the first set of content items and then select the second set of user interest weights 318 based on the selected stochastic policy.

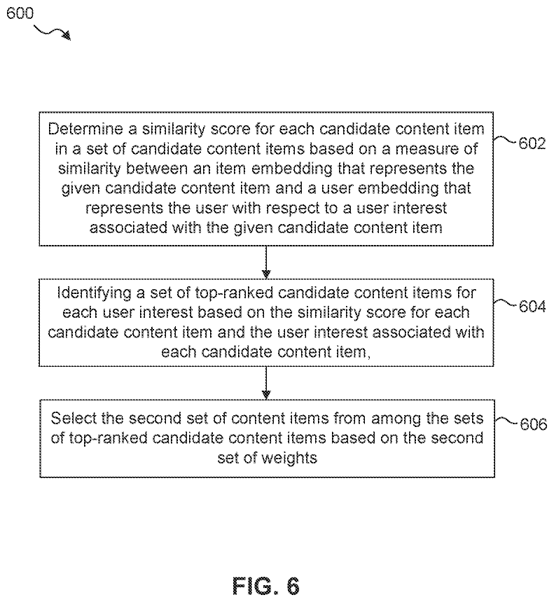

FIG. 6 is a flow diagram of a method 600 for identifying content items to recommend to a user based on a set of user interest weights selected by an ML model (e.g., a MAB, CMAB or RL model), according to some embodiments. Method 600 may be used, for example, to implement 512 of method 500. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to the embodiment of content recommendation system 128 depicted in FIG. 3. However, method 600 is not limited to that example embodiment.

In 602, content item similarity scorer 316 determines a similarity score 320 for each candidate content item in a set of candidate content items based on a measure of similarity between a content item embedding (e.g., from data store 310) that represents the given candidate content item and a user embedding (e.g., from data store 308) that represents user 132 with respect to a user interest associated with the given candidate content item.

In 604, recommendations generator 326 identifies a set of top-ranked candidate content items for each user interest based on the similarity score for each candidate content item and the user interest associated with each candidate content item.

In 606, recommendations generator 326 selects the second set of recommended content items 328 from among the sets of top-ranked candidate content items based on the second set of user interest weights 318. For example, recommendations generator 326 may utilize the second set of user interest weights 318 to determine a particular number of top-ranked candidate content items to obtain from each set.

### Example Computer System

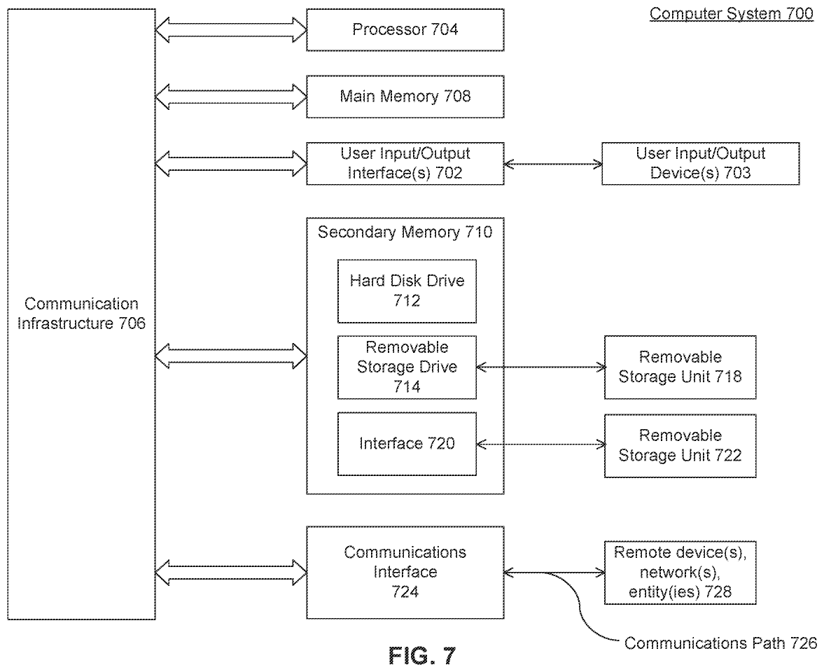

Various embodiments may be implemented, for example, using one or more well-known computer systems, such as computer system 700 shown in FIG. 7. For example, one or more of media device 106, remote control 110, content server(s) 120, system server(s) 126, content recommendation system 128, user interest weight determiner 312, ML model 314, content item similarity scorer 316, recommendations generator 326, RL model 402, or state and reward modeler 404 may be implemented using combinations or sub-combinations of computer system 700. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for recommending content items to a user, comprising:
selecting, by at least one computer processor, a first set of content items to recommend to the user based at least on a first set of weights respectively associated with different user interests in a plurality of user interests;
causing the first set of content items to be presented to the user;
determining a measure of user interaction with the first set of content items;
providing the measure of user interaction with the first set of content items to a machine learning (ML) model, wherein the ML model comprises one of a multi-arm bandit (MAB) model, a contextual MAB (CMAB) model or a reinforcement learning (RL) model;
selecting, by the ML model and based at least on the measure of user interaction with the first set of content items, a second set of weights respectively associated with the different user interests;
selecting a second set of content items to recommend to the user based at least on the second set of weights; and
causing the second set of content items to be presented to the user.

2. The computer-implemented method of claim 1, wherein determining the measure of user interaction with the first set of content items comprises determining a measure of one or more of:
user selections of content items in the first set of content items;
user launches of content items in the first set of content items for playback; or
user playback durations of content items in the first set of content items.

3. The computer-implemented method of claim 1, wherein the ML model comprises the CMAB model, the method further comprises providing context information to the ML model, and selecting the second set of weights respectively associated with the different user interests comprises:
selecting, by the ML model and based at least on the context information and the measure of user interaction with the first set of content items, the second set of weights respectively associated with the different user interests.

4. The computer-implemented method of claim 3, wherein providing the context information to the ML model comprises providing one or more of:
a day of a week;
a time of day;
a date;
a location; or
a device type.

5. The computer-implemented method of claim 1, wherein the ML model comprises the RL model, the method further comprises providing state information to the ML model, and selecting the second set of weights respectively associated with the different user interests comprises:
selecting, by the ML model and based at least on the state information and the measure of user interaction with the first set of content items, the second set of weights respectively associated with the different user interests.

6. The computer-implemented method of claim 4, wherein providing the state information to the ML model comprises providing one or more of:
a retention rate associated with the user;
a measure of activity of the user with respect to a media system;
a measure of engagement by the user with content items per session;
an indication of diversified items viewed by the user;
exploration or collaborative filtering information associated with a user interest of the user; or
context information.

7. The computer-implemented method of claim 1, wherein the plurality of user interests comprise:
a plurality of genres; or
a plurality of content item clusters.

8. The computer-implemented method of claim 1, wherein selecting the second set of content items to recommend to the user based at least on the second set of weights comprises:
determining a similarity score for each candidate content item in a set of candidate content items based on a measure of similarity between an item embedding that represents the given candidate content item and a user embedding that represents the user with respect to a user interest associated with the given candidate content item;
based on the similarity score for each candidate content item and the user interest associated with each candidate content item, identifying a set of top-ranked candidate content items for each user interest; and
selecting the second set of content items from among the sets of top-ranked candidate content items based on the second set of weights.

9. The computer-implemented method of claim 1, wherein selecting the second set of weights comprises:
selecting the second set of weights based at least on the measure of user interaction with the first set of content items and historical trial information that specifies, for each of one or more prior trials, a set of weights selected by the ML model and a measure of user interaction with a set of content items identified based on the set of weights selected by the ML model and presented to the user.

10. A system for recommending content items to a user, comprising:
one or more memories; and
at least one processor each coupled to at least one of the memories and configured to perform operations comprising:
selecting, by at least one computer processor, a first set of content items to recommend to the user based at least on a first set of weights respectively associated with different user interests in a plurality of user interests;
causing the first set of content items to be presented to the user;
determining a measure of user interaction with the first set of content items;
providing the measure of user interaction with the first set of content items to a machine learning (ML) model, wherein the ML model comprises one of a multi-arm bandit (MAB) model, a contextual MAB (CMAB) model or a reinforcement learning (RL) model;
selecting, by the ML model and based at least on the measure of user interaction with the first set of content items, a second set of weights respectively associated with the different user interests;
selecting a second set of content items to recommend to the user based at least on the second set of weights; and
causing the second set of content items to be presented to the user.

11. The system of claim 10, wherein determining the measure of user interaction with the first set of content items comprises determining a measure of one or more of:
user selections of content items in the first set of content items;
user launches of content items in the first set of content items for playback; or
user playback durations of content items in the first set of content items.

12. The system of claim 10, wherein the ML model comprises the CMAB model, the operations further comprise providing context information to the ML model, and selecting the second set of weights respectively associated with the different user interests comprises:
selecting, by the ML model and based at least on the context information and the measure of user interaction with the first set of content items, the second set of weights respectively associated with the different user interests.

13. The system of claim 12, wherein providing the context information to the ML model comprises providing one or more of:
a day of a week;
a time of day;
a date;
a location; or
a device type.

14. The system of claim 10, wherein the ML model comprises the RL model, the operations further comprise providing state information to the ML model, and selecting the second set of weights respectively associated with the different user interests comprises:
selecting, by the ML model and based at least on the state information and the measure of user interaction with the first set of content items, the second set of weights respectively associated with the different user interests.

15. The system of claim 14, wherein providing the state information to the ML model comprises providing one or more of:
a retention rate associated with the user;
a measure of activity of the user with respect to a media system;
a measure of engagement by the user with content items per session;
an indication of diversified items viewed by the user;
exploration or collaborative filtering information associated with a user interest of the user; or
context information.

16. The system of claim 10, wherein the plurality of user interests comprise:
a plurality of genres; or
a plurality of content item clusters.

17. The system of claim 10, wherein selecting the second set of content items to recommend to the user based at least on the second set of weights comprises:
determining a similarity score for each candidate content item in a set of candidate content items based on a measure of similarity between an item embedding that represents the given candidate content item and a user embedding that represents the user with respect to a user interest associated with the given candidate content item, and
based on the similarity score for each candidate content item and the user interest associated with each candidate content item, identifying a set of top-ranked candidate content items for each user interest; and
selecting the second set of content items from among the sets of top-ranked candidate content items based on the second set of weights.

18. The system of claim 10, wherein selecting the second set of weights comprises:
selecting the second set of weights based at least on the measure of user interaction with the first set of content items and historical trial information that specifies, for each of one or more prior trials, at least a set of weights selected by the ML model and a measure of user interaction with a set of content items identified based on the set of weights selected by the ML model and presented to the user.

19. A non-transitory computer-readable medium having instructions stored thereon that, when executed by at least one computing device, causes the at least one computing device to perform operations for recommending content items to a user, the operations comprising:
selecting a first set of content items to recommend to the user based at least on a first set of weights respectively associated with different user interests in a plurality of user interests;
causing the first set of content items to be presented to the user;
determining a measure of user interaction with the first set of content items;
providing the measure of user interaction with the first set of content items to a machine learning (ML) model, wherein the ML model comprises one of a multi-arm bandit (MAB) model, a contextual MAB (CMAB) model or a reinforcement learning (RL) model;
selecting, by the ML model and based at least on the state information and the measure of user interaction with the first set of content items, a second set of weights respectively associated with the different user interests;
selecting a second set of content items to recommend to the user based at least on the second set of weights; and
causing the second set of content items to be presented to the user.

20. The non-transitory computer-readable medium of claim 19, wherein determining the measure of user interaction with the first set of content items comprises determining a measure of one or more of:
user selections of content items in the first set of content items;
user launches of content items in the first set of content items for playback; or
user playback durations of content items in the first set of content items.
